(19) United States
(12) Patent Application Publication
(10) Pub. No.: US 2012/0102254 A1
(43) Pub. Date: Apr. 26, 2012

(54) Virtualized Peripheral Hardware Platform System

(75) Inventors: Chun-Ming Huang, Hsinchu City (TW); Chin-Long Wey, Hsinchu City (TW); Hui-Ming Lin, Hsinchu City (TW); Chien-Ming Wu, Hsinchu City (TW); Kai-Chao Yang, Hsinchu City (TW); Yu-Tsang Chang, Hsinchu City (TW)

(73) Assignee: National Chip Implementation Center National Applied Research Laboratories., Hsinchu City (TW)

(21) Appl. No.: 12/961,783

(22) Filed: Dec. 7, 2010

(30) Foreign Application Priority Data
Oct. 22, 2010 (TW) 099136010

(51) Int. Cl. G06F 13/20

(52) U.S. Cl. 710/313

(57) ABSTRACT

The present invention discloses a virtualized peripheral hardware platform system. The virtualized peripheral hardware platform system includes a first hardware platform and a software platform, which is executed in a second hardware platform. The first hardware platform is in signal communication with the second hardware platform. The software platform not only simulates the operation of the peripheral device of the first hardware platform but also simulates input signals of virtual peripheral devices and then transmits the input signals to the first hardware platform to conduct further calculations. Furthermore, the input/output (I/O) interface of the second hardware platform can be simulated as the I/O interface of the first hardware platform, so as to decrease the number of the I/O interface which the first hardware platform needed and downsize the first hardware platform.

### BACKGROUND OF THE INVENTION

1. Technical Field

The present invention relates to hardware platform systems and, more specifically, to a virtualized peripheral hardware platform system.

2. Description of Related Art

An embedded system, as a complex component in computer hardware and software, is known to be a device for controlling, monitoring or assisting apparatuses, machines or even factory operations, being particularly a system developed for a specific purpose. Among emerging embedded-system-based products, common ones include mobile phones, PDA, GPS, Set-Top-Box and embedded servers and thin clients.

Processors and chip sets for embedded systems are required to be compact, efficient in heat dissipation and power. Thus, a SoC (System-on-Chip) that is highly integrated is usually used as the processing core. In addition, in embedded systems, software and hardware are inseparable. However, the development process of software in the core processers used in most embedded systems is different from that for the programs of normal desktop computers. Therefore, in order to rapidly develop system software on various platforms, the developers of embedded systems usually provide simulation environments and hardware platform to their development staff so as to enable them to develop software programs, without using any physical hardware platform. These software programs are then to be integrated after being designed and verified on a hardware platform.

A common difficulty of the developers' hardware platform is that while a hardware platform supporting peripheral interface of multiple types is available, it is limited by space or cost considerations. Consequently, it is hard to make one hardware platform supporting peripheral interface of all available types. Even if the peripheral interface of all available types could be put on a single hardware platform, the resultant hardware platform would be too bulky to be portable, not to mention the problems related to its design complexity.

### SUMMARY OF THE INVENTION

The present invention provides a virtualized peripheral hardware platform system, which merely provides a first hardware platform with hardware units that are required minimally, and regards a physical peripheral device connected to a second hardware platform as the peripheral device of the first hardware platform, so as to simplify the structural complexity of the first hardware platform.

The present invention provides the virtualized peripheral hardware platform system, wherein a software platform is executed on the second hardware platform, and operations of the peripheral device of the first hardware platform is simulated by means of the software platform, so as to reduce the number of input/output (I/O) interfaces required on the first hardware platform, and thereby downsize the first hardware platform.

The present invention provides the virtualized peripheral hardware platform system, wherein the usability of the first hardware platform can be improved because the complexity of the first hardware platform is reduced and the same first hardware platform is enabled to work with the software platform to simulate various peripheral signals.

For achieving the aforementioned effects, the present invention provides a virtualized peripheral hardware platform system, which comprises: a first hardware platform, which includes: a data-processing module for receiving and processing a signal data to generate a corresponding first peripheral signal; a first peripheral-converting module for acquiring and encoding the first peripheral signal and into a first interface signal; and a first interface module for receiving and transmitting the first interface signal; and a software platform configured to be executed in a second hardware platform, the second hardware platform being in signal communication with the first interface module, and connected to at least a physical peripheral device, and the software platform including: a second interface module for receiving and transmitting the first interface signal; and a second peripheral-converting module for receiving and decoding the first interface signal so as to generate a second peripheral signal, wherein the second peripheral-converting module then transmits the second peripheral signal to a virtual peripheral device or the corresponding physical peripheral device, wherein, when the second peripheral signal is transmitted to the virtual peripheral device, the virtual peripheral device simulates the second peripheral signal, and when the second peripheral signal is transmitted to the physical peripheral device, the physical peripheral device operates according to the second peripheral signal.

By implementing the present invention, at least the following progressive effects can be achieved:

1. The present invention connects the second hardware platform equipped with the software platform to the first hardware platform, so as to take the physical peripheral device connected to the second hardware platform as the peripheral device of the first hardware platform, thereby downsizing the first hardware platform.

2. The present invention uses peripheral-virtualizing technology to virtualize the peripheral device supported by the first hardware platform, thereby decreasing the manufacturing costs, simplifying the circuit structure, downsizing the platform and improving the usability of the hardware platform.

3. The present invention may combine peripheral-virtualizing and peripheral-expanding technologies to allow various peripheral devices to be easily applied to the hardware platform, thereby accelerating development of new peripheral interfaces at hardware-platform suppliers' side and reducing the costs required by developing new peripheral interface.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a structural diagram of a virtualized peripheral hardware platform system according to one embodiment of the present invention;

FIG. 2 is an operational diagram of the virtualized peripheral hardware platform system of the embodiment of the present invention;

FIG. 3A shows a first aspect of a data-processing module according to the embodiment of the present invention;

FIG. 3B shows a second aspect of the data-processing module according to the embodiment of the present invention;

FIG. 3C shows a third aspect of the data-processing module according to the embodiment of the present invention;

FIG. 3D shows a fourth aspect of the data-processing module according to the embodiment of the present invention;

FIG. 4 is an operational diagram of a first peripheral-converting module according to the embodiment of the present invention embodiment;

FIG. 5 is an operational diagram of a second peripheral-converting module according to the embodiment of the present invention embodiment;

FIG. 6A shows a fifth aspect of the data-processing module according to the embodiment of the present invention;

FIG. 6B shows a sixth aspect of the data-processing module according to the embodiment of the present invention;

FIG. 6C shows a seventh aspect of the data-processing module according to the embodiment of the present invention; and

FIG. 6D shows an eighth aspect of the data-processing module according to the embodiment of the present invention.

### DETAILED DESCRIPTION OF THE INVENTION

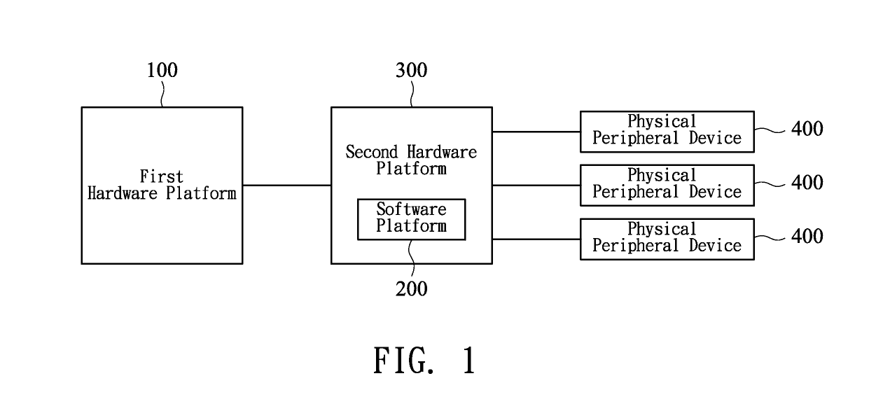

Referring to FIG. 1, the present embodiment is a virtualized peripheral hardware platform system, which comprises: a first hardware platform 100 and a software platform 200. Therein, the software platform 200 is executed on a second hardware platform 300. The second hardware platform 300 may be, for example, a personal computer platform, an embedded system platform or a portable computer platform. The second hardware platform 300 is in signal communication with the first hardware platform 100, and the second hardware platform 300 comprises at least one input/output (I/O) interface to connect to at least a physical peripheral device 400.

The first hardware platform 100 may be merely equipped with basic hardware units and execute the peripheral signals which are generated by the software platform 200 on the second hardware platform 300 to simulate the input or output signals of the peripheral devices. Therefore, the first hardware platform 100 is applicable for the development and testing of different systems with different functions, so developers need not to develop dedicated hardware platforms for meeting demands of different peripheral devices. The usability of the first hardware platform 100 is thus significantly increased.

Thereby, it is possible to simulate the operation of the peripheral device of the first hardware platform 100 by the software platform 200 with the assistance of peripheral-signal acquiring and virtualization technologies. When the first hardware platform 100 and the second hardware platform 300 come into signal communication, all of the peripheral signals sent out by the first hardware platform 100 will be transmitted to the software platform 200 on the second hardware platform 300, so that the software platform 200 can simulate the output data represented by the peripheral signal and display the data through a display interface of the software platform 200.

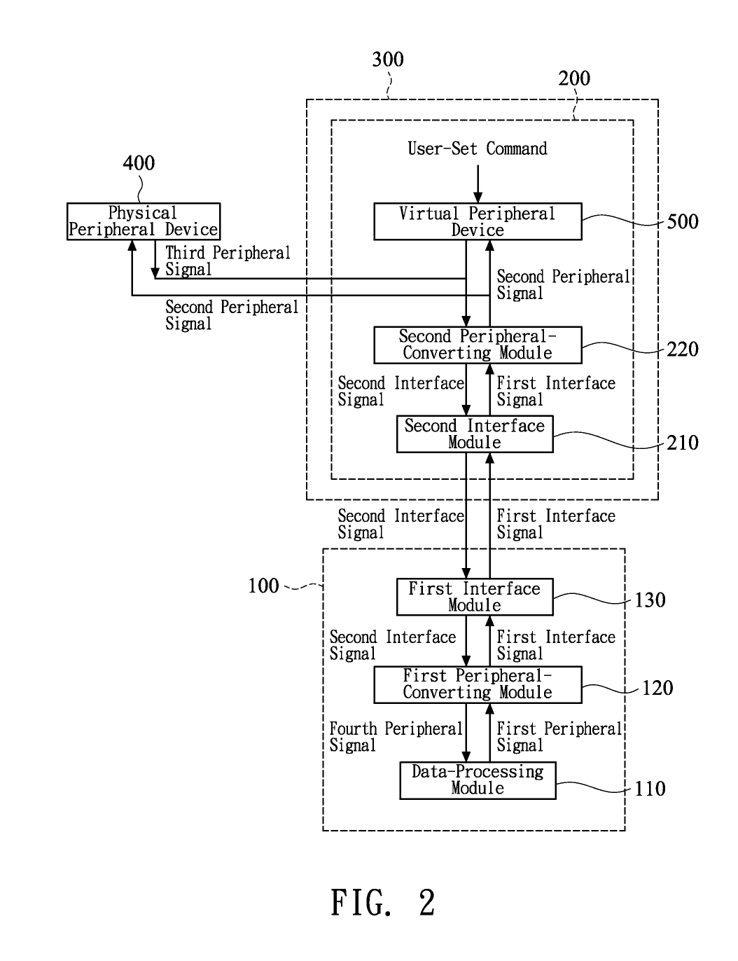

Additionally, referring to FIG. 2, a virtual peripheral device 500 on the software platform 200 may output simulation signals to the first hardware platform 100, and these simulation signals are also converted into peripheral signals to be transmitted to the first hardware platform 100 for further operation and processing. Preferably, the physical peripheral device 400 connected to the second hardware platform 300 may be simulated as a peripheral device of the first hardware platform 100, so that the peripheral device connected to the second hardware platform 300 may be regarded as the peripheral device of the first hardware platform 100. Thereby, the number of I/O interfaces required by the first hardware platform 100 can be reduced and in turn the first hardware platform 100 can be downsized in both area and volume.

Referring to FIG. 2, the first hardware platform 100 may comprise: a data-processing module 110, a first peripheral-converting module 120 and a first interface module 130.

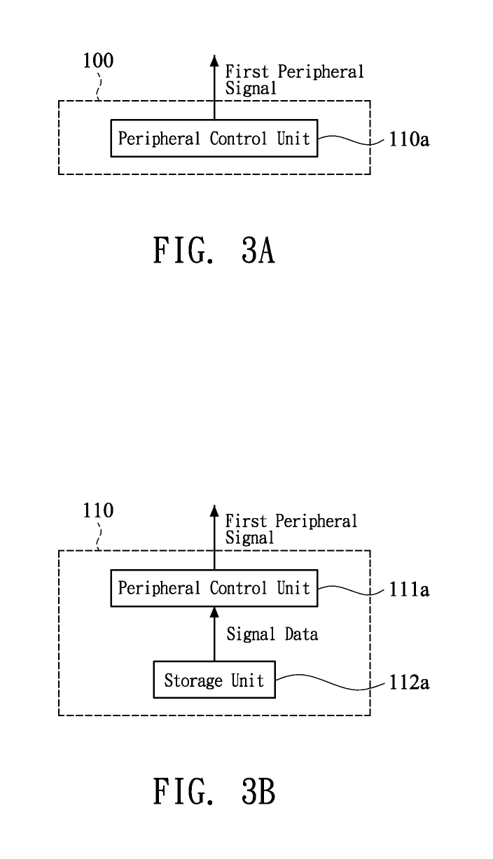

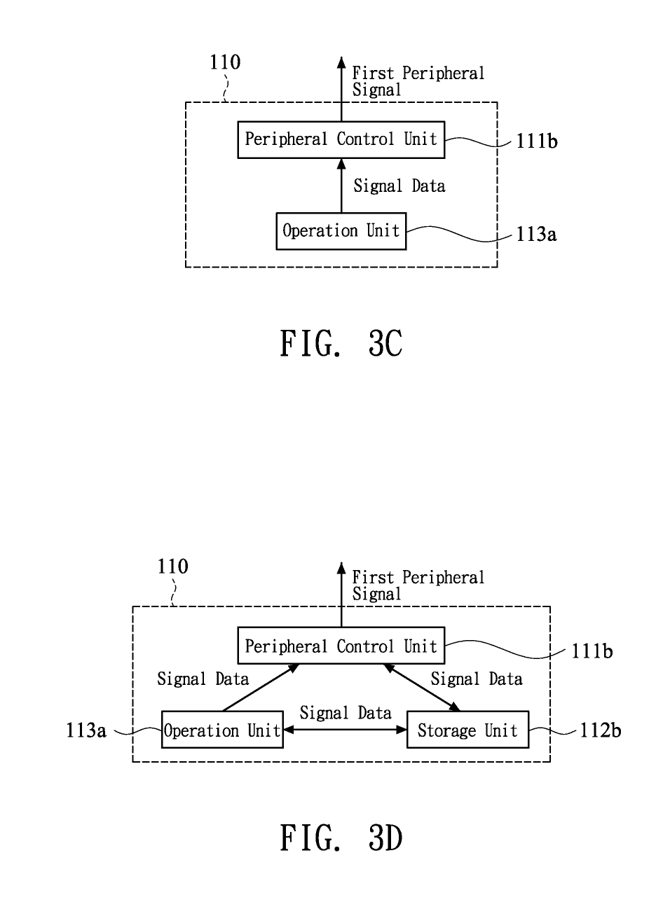

The data-processing module 110 is configured to receive and process a signal data to generate a corresponding first peripheral signal. The signal data may be generated through a default program preset in the first hardware platform 100. As shown in FIG. 3A, the data-processing module 110 may only include a peripheral control unit 111a. The peripheral control unit 111a generates the corresponding first peripheral signal according to the signal data generated through the default program preset in the first hardware platform 100. As shown in FIG. 3B, the data-processing module 110 may further comprise a storage unit 112a for registering the signal data.

Referring to FIG. 3C, there is another aspect of the data-processing module 110, which comprises: an operation unit 113a and a peripheral control unit 111b. Therein, the operation unit 113a generates a signal data according to a default program in the first hardware platform 100, while the peripheral control unit 111b generates a first peripheral signal according to the signal data. As shown in FIG. 3D, the data-processing module 110 may further comprise a storage unit 112b for registering the signal data. The storage unit 112b may register the signal data not processed by the operation unit 113a yet or the signal data processed by the operation unit 113a for the peripheral control unit 111b to use.

Referring back to FIG. 2, the first peripheral-converting module 120 acquires the first peripheral signal generated by the data-processing module 110 and encodes it into a first interface signal. The first interface module 130, after receiving the first interface signal, transmits the first interface signal to the software platform 200. Therein, the first interface module 130 is in signal communication with the second hardware platform 300 by means of a wireless interface or a wired interface. The wired interface may be, for example, a parallel interface module or a serial interface module, such as a USB interface module.

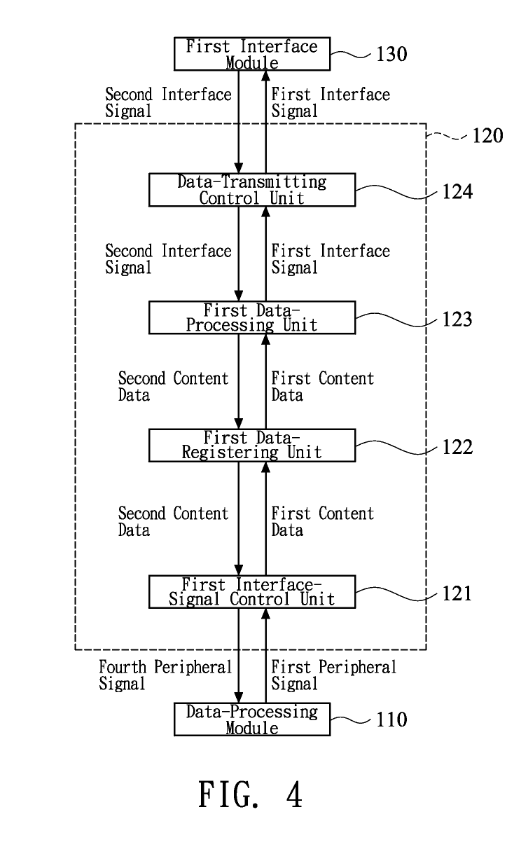

As shown in FIG. 4, the first peripheral-converting module 120 comprises: a first interface-signal control unit 121, a first data-registering unit 122, a first data-processing unit 123 and a data-transmitting control unit 124. The first peripheral-converting module 120 mainly serves to acquire the first peripheral signal sent out by the data-processing module 110, and acquire a second interface signal sent out by the software platform 200.

The first interface-signal control unit 121 serves to identify the type of the first peripheral signal sent out by the data-processing module 110, and to acquire a first content data of the first peripheral signal for registering it in the first data-registering unit 122. The first data-processing unit 123 converts the first content data to the first interface signal, and then the data-transmitting control unit 124 transmits the first interface signal to the first interface module 130.

Referring to FIG. 2 again, the software platform 200 comprises: a second interface module 210 and a second peripheral-converting module 220. Therein, the second interface module 210 receives the first interface signal from the first interface module 130 and forwards it to the second peripheral-converting module 220, so that the second peripheral-converting module 220 receives and decodes the first interface signal to generate a second peripheral signal. The second peripheral-converting module 220 then transmits the second peripheral signal to a virtual peripheral device 500 in the software platform 200 or the corresponding physical peripheral device 400.

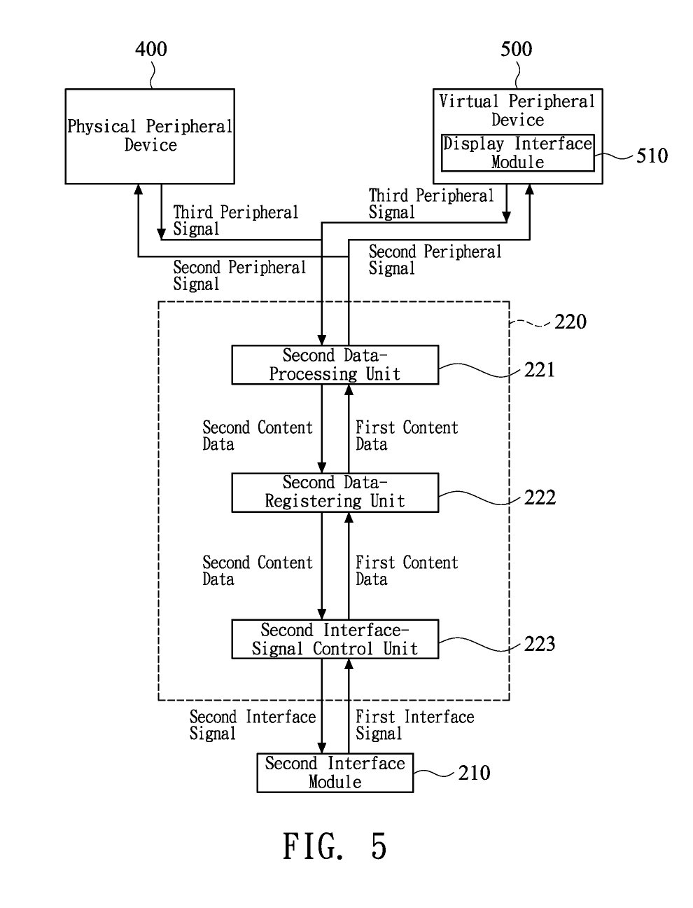

As shown in FIG. 5, the second peripheral-converting module 220 comprises: a second data-processing unit 221, a second data-registering unit 222 and a second interface-signal control unit 223. The second peripheral-converting module 220 mainly serves to acquire the first interface signal set out by the first hardware platform 100, and to acquire a third peripheral signal set out by the virtual peripheral device 500 or the physical peripheral device 400.

When the second peripheral-converting module 220 acquires the first interface signal from the second interface module 210, the second interface-signal control unit 223 decodes the first interface signal to obtain a first content data of the first interface signal. The first content data may be registered in the second data-registering unit 222, and then be converted by the second data-processing unit 221 into second peripheral signal to be transmitted to the virtual peripheral device 500 or the corresponding physical peripheral device 400.

When the second peripheral signal is transmitted to the virtual peripheral device 500, the virtual peripheral device 500 can simulate and display the second peripheral signal. Therein, the virtual peripheral device 500 further comprises a display interface module 510 for displaying the simulation result of the second peripheral signal. In addition, when the second peripheral signal is transmitted to the physical peripheral device 400 connected with the second hardware platform 300, the physical peripheral device 400 operates according to the second peripheral signal.

Moreover, the first hardware platform 100 can also process the signals outputted by the software platform 200. Therein, the physical peripheral device 400 operates and sends out the corresponding third peripheral signal that is transmitted to the first hardware platform 100 by means of the software platform 200 for processing. A user may also input signals to be processed by means of the software platform 200 so as to generate a corresponding user-set command (as shown in FIG. 2). The virtual peripheral device 500 may further receive the user-set command and send out the third peripheral signal corresponding to the user-set command.

As shown in FIG. 2, upon receiving the third peripheral signal, the second peripheral-converting module 220 encodes the third peripheral signal to generate a second interface signal, and the second interface signal can be transmitted to the first peripheral-converting module 120 by means of the second interface module 210 and the first interface module 130. After receiving the second interface signal, the first peripheral-converting module 120 decodes the second interface signal into a fourth peripheral signal and transmits it to the data-processing module 110, so that the fourth peripheral signal is converted to the signal data for processing. The foregoing first interface signal and second interface signal are subject to the types that can be transmitted through the first interface module 130 and the second interface module 210.

As shown in FIG. 5, the second data-processing unit 221 in the second peripheral-converting module 220 acquires and reads out a second content data from the third peripheral signal, and registers the second content data in the second data-registering unit 222. The second interface-signal control unit 223 generates the second interface signal according to the second content data and transmits the second interface signal by means of the second interface module 210.

As shown in FIG. 4, when receiving the second interface signal by the first interface module 130 of the first hardware platform 100, the second interface signal is further sent to the data-transmitting control unit 124, and the second interface signal is sent to and then decoded by the first data-processing unit 123, so as to obtain the second content data of the second interface signal and register it in the first data-registering unit 122. Then the first interface-signal control unit 121 converts the second content data into the fourth peripheral signal.

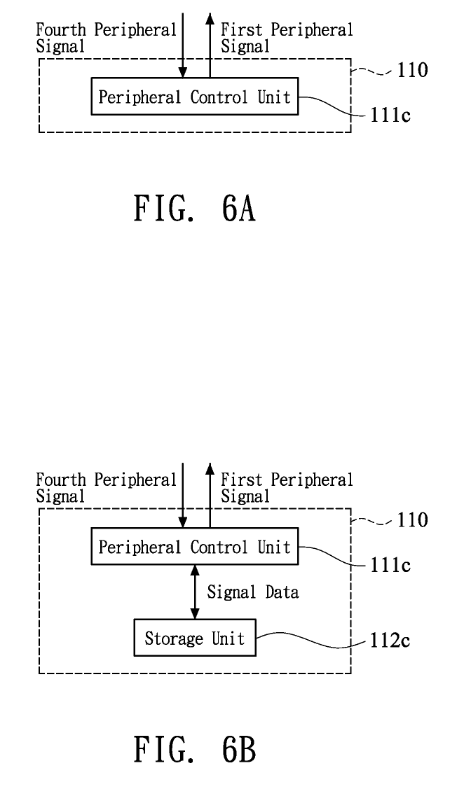

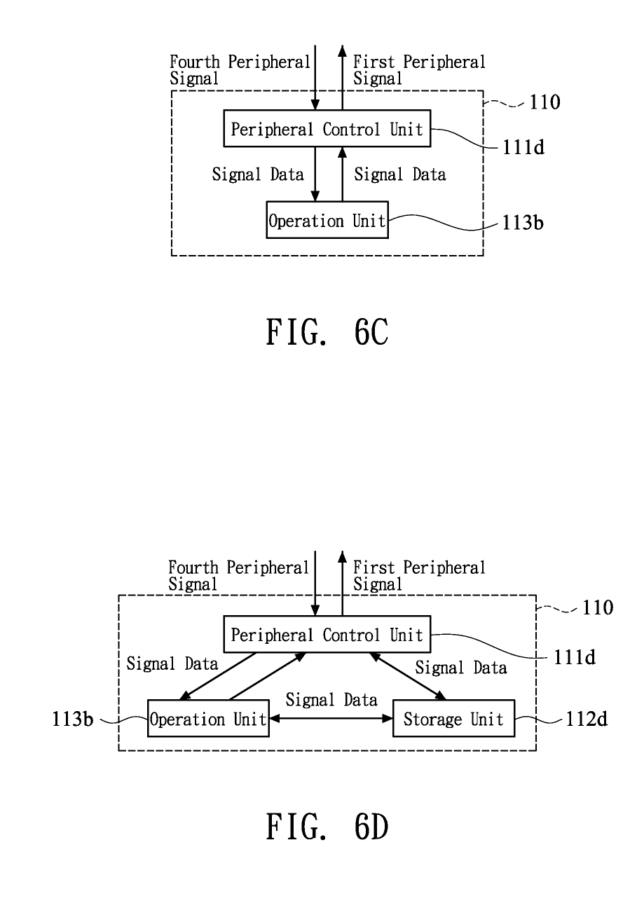

FIG. 6A shows a fifth aspect of the data-processing module 110 according to the embodiment of the present invention. FIG. 6B shows a sixth aspect of the data-processing module 110 according to the embodiment of the present invention. FIG. 6C shows a seventh aspect of the data-processing module 110 according to the embodiment of the present invention. FIG. 6D shows an eighth aspect of the data-processing module 110 according to the embodiment of the present invention.

Therefore, the signal data may be generated by the default program preset in the first hardware platform 100 or be acquired the signal output by the software platform 200. As shown in FIG. 6A, the data-processing module 110 may include a peripheral control unit 111c for receiving a fourth peripheral signal and converting the fourth peripheral signal into the signal data, so as to generate the corresponding first peripheral signal according to the signal data. Further referring to FIG. 6B, the data-processing module 110 may further include a storage unit 112c for registering the signal data.

Referring to FIG. 6C, there is another aspect of the data-processing module 110, which comprises: a peripheral control unit 111d and an operation unit 113b. Therein, the peripheral control unit 111d receives the fourth peripheral signal, and converts the fourth peripheral signal into the signal data, and the operation unit 113b receives and processes the signal data converted by the peripheral control unit 111d. The peripheral control unit 111d also receives the signal data processed by the operation unit 113b so as to generate the corresponding first peripheral signal and transmits the same. Referring to FIG. 6D, the data-processing module 110 may further comprise a storage unit 112d for registering the signal data. The storage unit 112d registers the signal data processed by the operation unit 113a for the peripheral control unit 111d to use.

The foregoing operation unit 113a or 113b may be an FPGA circuit or a SoC chip. Alternatively, the operation unit 113a or 113b and the storage unit 112b or 112d may be integrated on a SoC chip. Preferably, the operation unit 113a or 113b, the storage unit 112b or 112d and the peripheral control unit 111b or 111d may be also integrated on a SoC chip.

In the course of manufacturing the first hardware platform 100 (for example, an embedded system development board), limited by requirements for the manufacturing costs, product area, R&D schedule and others, the developer may not equip the first hardware platform 100 with all peripheral wires and connectors. For example, in the event that the developer initially provided the development board with merely the peripheral interface for UART, VGA and PS2 and later desires to add USB interface, the developer has to make a new development board. However, as to the first hardware platform 100 of the present embodiment, for additionally supporting USB interface, the developer has only to update the software platform 200 but not replace the entire first hardware platform 100. Thus, the developer can forestall all its competitors by launching products first and then updating the products through adding the software platform with additional peripheral interface, while also shortening the manufacturing schedule and reducing the manufacturing costs.

Moreover, by preserving the core hardware unit in the first hardware platform 100 for processing peripheral signals, the efficiency of signal processing can be ensued. Also, by regarding the peripheral devices (e.g. displays, audio devices, keyboards, etc.) connected to the second hardware platform 300 as those connected to the first hardware platform 100, the number of physical I/O interfaces required on the first hardware platform 100 can be significantly reduced, thereby simplifying the complexity of the overall circuit. In addition, the software platform 200 can simulate the operation of the peripheral devices so as to save space on the first hardware platform 100 and reduce the complexity of the overall circuit.

By reducing the number of I/O interfaces and simplifying the circuit, the first hardware platform 100 can be downsized to be as small as a flash drive, being portable by a development engineer so the development engineer can easily build a ready development environment by connecting the first hardware platform 100 with an in-situ second hardware platform 300 of a software platform 200. To developers, the reduced manufacturing costs allow them to put the first hardware platform 100 into mass production, and thereby popularize the development platforms on the mass market. Meantime, the developers need not make different first hardware platforms for different peripheral devices, and may use the same first hardware platform 100 to simulate input and output signals of all peripheral devices, thereby enhancing the usability of the first hardware platform 100.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A virtualized peripheral hardware platform system, comprising:
a first hardware platform, which includes:
a data-processing module for receiving and processing a signal data to generate a corresponding first peripheral signal;
a first peripheral-converting module for acquiring and encoding the first peripheral signal into a first interface signal; and
a first interface module for receiving and transmitting the first interface signal; and
a software platform configured to be executed in a second hardware platform, the second hardware platform being in signal communication with the first interface module and connected to at least one physical peripheral device, and the software platform including:
a second interface module for receiving and transmitting the first interface signal; and
a second peripheral-converting module for receiving and decoding the first interface signal so as to generate a second peripheral signal, wherein the second peripheral-converting module then transmits the second peripheral signal to a virtual peripheral device or the corresponding physical peripheral device,
wherein, when the second peripheral signal is transmitted to the virtual peripheral device, the virtual peripheral device simulates the second peripheral signal, and when the second peripheral signal is transmitted to the physical peripheral device, the physical peripheral device operates according to the second peripheral signal.

2. The virtualized peripheral hardware platform system of claim 1, wherein the second peripheral-converting module further receives a third peripheral signal, and encodes the third peripheral signal to generate a second interface signal, the second interface signal then being transmitted to the first peripheral-converting module by means of the second interface module and the first interface module, the first peripheral-converting module decoding the second interface signal into a fourth peripheral signal and transmitting the fourth peripheral signal to the data-processing module, and the data-processing module converting the fourth peripheral signal into the signal data.

3. The virtualized peripheral hardware platform system of claim 2, wherein the data-processing module includes:
a peripheral control unit for receiving the fourth peripheral signal and converting the fourth peripheral signal into the signal data, so as to generate the corresponding first peripheral signal according to the signal data.

4. The virtualized peripheral hardware platform system of claim 2, wherein the data-processing module includes:
a peripheral control unit for receiving the fourth peripheral signal and converting the fourth peripheral signal into the signal data, so as to generate the corresponding first peripheral signal according to the signal data; and
a storage unit for registering the signal data.

5. The virtualized peripheral hardware platform system of claim 2, wherein the data-processing module includes: a peripheral control unit and an operation unit, the peripheral control unit receiving the fourth peripheral signal and converting the fourth peripheral signal into the signal data, the operation unit processing and calculating the signal data transmitted from the peripheral control unit, and the peripheral control unit receiving the signal data processed and calculated by the operation unit so as to generate and transmit the corresponding first peripheral signal.

6. The virtualized peripheral hardware platform system of claim 2, wherein the data-processing module includes: a peripheral control unit, a storage unit and an operation unit, the peripheral control unit receiving the fourth peripheral signal and converting the fourth peripheral signal into the signal data, the operation unit processing and calculating the signal data transmitted from the peripheral control unit, the storage unit registering the signal data processed and calculated by the operation unit, and the peripheral control unit receiving the signal data processed and calculated by the operation unit in order to generate and transmit the corresponding first peripheral signal.

7. The virtualized peripheral hardware platform system of claim 2, wherein the third peripheral signal is sent by the virtual peripheral device or the physical peripheral device.

8. The virtualized peripheral hardware platform system of claim 7, wherein the virtual peripheral device further receives a user-set command so as to generate the corresponding third peripheral signal.

9. The virtualized peripheral hardware platform system of claim 2, wherein the first peripheral-converting module includes:
a first interface-signal control unit for identifying the type of the first peripheral signal and acquiring a first content data of the first peripheral signal;
a first data-registering unit for registering the first content data;
a first data-processing unit for converting the first content data to generate the first interface signal; and
a data-transmitting control unit for transmitting the first interface signal,
wherein the data-transmitting control unit also receives the second interface signal, and the first data-processing unit decodes the second interface signal to obtain a second content data of the second interface signal, while the first data-registering unit registers the second content data, and the first interface-signal control unit converts the second content data into the fourth peripheral signal.

10. The virtualized peripheral hardware platform system of claim 2, wherein the second peripheral-converting module includes:
a second data-processing unit for obtaining and reading a second content data of the third peripheral signal;
a second data-registering unit for registering the second content data; and
a second interface-signal control unit for generating the second interface signal according to the second content data,
wherein the second interface-signal control unit also reads the first interface signal so as to obtain a first content data of the first interface signal, and the second data-registering unit registers the first content data, while the second data-processing unit converts the first content data into the second peripheral signal and transmits the second peripheral signal to the virtual peripheral device or the corresponding physical peripheral device.

11. The virtualized peripheral hardware platform system of claim 1, wherein the data-processing module includes:
a peripheral control unit for generating the first peripheral signal according to the signal data.

12. The virtualized peripheral hardware platform system of claim 1, wherein the data-processing module includes:
a peripheral control unit for generating the first peripheral signal according to the signal data; and
a storage unit for registering the signal data.

13. The virtualized peripheral hardware platform system of claim 1, wherein the data-processing module includes:
an operation unit for generating the signal data; and
a peripheral control unit for generating the first peripheral signal according to the signal data.

14. The virtualized peripheral hardware platform system of claim 1, wherein the data-processing module includes:
an operation unit for generating the signal data;
a storage unit for registering the signal data; and
a peripheral control unit for generating the first peripheral signal according to the signal data.

15. The virtualized peripheral hardware platform system of claim 1, wherein the second hardware platform is in signal communication with the first interface module by means of one wireless interface or one wired interface.

16. The virtualized peripheral hardware platform system of claim 15, wherein the wired interface is one parallel interface module or one serial interface module.

17. The virtualized peripheral hardware platform system of claim 1, wherein the virtual peripheral device further comprises a display interface module for converting and displaying a simulation result of the second peripheral signal.

18. The virtualized peripheral hardware platform system of claim 1, wherein the second hardware platform is one personal computer platform, one embedded system platform or one portable computer platform.
